(19) United States
(12) Patent Application Publication
(10) Pub. No.: US 2007/0021535 A1
(43) Pub. Date: Jan. 25, 2007

(54) Flame-retardant polyamide molding composition

(75) Inventors: Roland Wursche, Dulmen (DE); Andreas Dowe, Borken (DE); Reinhard Beuth, Marl (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/448,914

(22) Filed: Jun. 8, 2006

(30) Foreign Application Priority Data
Jun. 8, 2005 (DE) 10 2005 026 265.1

(51) Int. Cl. C08K 5/49

(52) U.S. Cl. 524/115

(57) ABSTRACT

A flame retardant molding composition contains a) from 43 to 93.5 parts by weight of polyamide, b) from 2 to 12 parts by weight of melamine cyanurate, c) from 1.5 to 15 parts by weight of polyol having at least 3 OH groups per molecule, and d) from 3 to 30 parts by weight of an organophosphorus compound, with the proviso that the parts by weight of components a) to d) give a total of 100. The molding composition has excellent fire properties and, despite the use of the particulate material melamine cyanurate, is flexible.

### BACKGROUND OF THE INVENTION

1. Field of the Invention

The invention relates to a polyamide molding composition provided with flame retardancy and comprising a combination of melamine cyanurate, polyol, and organophosphorus compounds.

2. Description of the Related Art

Advantageous fundamental properties make polyamides, e.g. PA 12 or copolyamides derived therefrom, useful in molding compositions for applications in cable conduit, in cable sheathing, or in parts of cable sheathing. Other application sectors are electrical components in which moderate stiffness is desired. Examples of properties that are decisive here are adequate impact resistance at low temperatures, associated with good resistance to chemicals and hydrolysis. The conditions of use frequently require provision of flame retardancy integrated into these molding compositions. In the light of the discussion concerning the environmental and toxicological aspects of halogenated flame retardant additives, the market is demanding halogen-free solutions for these problems. Another requirement is V-0 classification to UL 94 in the range from 0.4 to 3.2 mm layer thickness. However, this usually leads, among other changes in fundamental properties, to a loss of flexibility, brought about via the high proportion of particulate flame retardants acting as filler. The possible uses of this class of materials are consequently disadvantageously restricted.

A number of different classes of compound can be used to provide flame retardancy in polyamides, e.g. halogen-containing compounds acting together with antimony oxides, and other examples being melamine compounds, such as melamine cyanurate or melamine phosphates, ammonium polyphosphate, melamine borate, zinc borate, red phosphorus, organophosphorus compounds, metal hydroxides, or a number of other inorganic compounds. These additives are often used in what are known as flame retardant systems which are composed of combinations of the specified classes of compound. In practice, formulation of flame-retardant molding compositions is difficult because firstly there is generally a number of further requirements placed upon the molding compositions, to some extent running contrary to the side effects caused by modification with flame retardant, and secondly there is no general transferability of defined flame retardant formulations between different classes of polymer, for example polyesters and polyamides. This is explained by the specific inherent properties of different polymers combined with the requirements placed upon the corresponding molding composition over and above the fire properties. By way of example, compatibility of the additives with the polymer matrix is difficult to predict and also depends on other materials added within a molding composition. There are even differences within representatives of one class of substance, for example the polyamides. By way of example, a polyamide having relatively high carboxamide group density, e.g. PA 6, has more advantageous fire performance than pure PA 12. Optimization is therefore necessary for each individual case.

U.S. Pat. No. 4,786,673 describes polyamide compositions specifically based on PA 11 and PA 12 with melamine cyanurate, adding from 0.5 to 10% of polyols, such as pentaerythritol, to improve fire properties. An additional improvement is obtained if the composition comprises from 0.2 to 2% of phosphoric acid or of a dicarboxylic acid as molecular weight regulator. These measures can give molding compositions which generate the classification V-0 at 0.8, 1.6, and 3.2 mm in the UL 94 test. The amount of the melamine cyanurate that has to be added in the case of a dodecanediacid-regulated PA 12 is stated as 15%, and the amount of the pentaerythritol in this case is 3%. When plasticized molding compositions were prepared with addition of about 12% of n-butylbenzenesulfonamide (BBSA), this flame retardant system could achieve a V-0 classification for PA 11 only at 3.2 mm. These data indicate that this technology cannot give flexible polyamide molding compositions based on PA 12 or PA 11 with excellent fire properties, i.e. with UL 94 classification V-0 also for 0.4, 0.8, and 1.6 mm. In fact, a formulation using PA 12 showed that at most a V-2 classification can be obtained.

Nor do other patent applications dealing with related compositions make any practicable proposals for solving these problems. By way of example, WO 98/45364 describes molding compositions composed of a polyester or of a polyamide, which can comprise not only reinforcing agents but also flame retardant combinations composed of melamine polyphosphate, of a carbonization catalyst, and of a carbonizer. This method cannot give flexible molding compositions. Similar considerations apply to U.S. Pat. No. 5,618,865.

WO 97/00916 describes aliphatic polyamide molding compositions which can comprise a combination of melamine cyanurate and pentaerythritol. Alongside this, it is essential that an inorganic tungsten compound is present. These systems, too, are unsuitable for providing flexible flame-retardant molding compositions.

JP 07 018 179 A describes flame-retardant polyamide compositions which comprise melamine cyanurate and up to 5% of compounds which derive from phosphoric acid, the latter being stabilizers. Here again, the teaching disclosed does not include the preparation of flexible, flame-retardant PA 12 molding compositions.

Overall, it is apparent that the known procedures are unsuitable for meeting the requirements set out above, namely provision of a flexible, halogen-free flame-retardant molding composition based on polyamide with excellent fire properties, i.e. V-0 to UL 94 in the range from 0.4 to 3.2 mm. The modulus of elasticity of the molding composition, being a measure of flexibility, should be approximately in the range of the modulus of elasticity of the underlying polyamide (that for PA 12 being about 1400 MPa), but preferably lower. Other properties required are good compatibility of the additives with the matrix, and very low volatility.

### SUMMARY OF THE INVENTION

It is an object of the present invention to provide a polyamide molding composition provided with flame retardancy, adequate impact resistance at low temperatures, good resistance to chemicals and hydrolysis, a V-0 classification to UL 94, preferably for a layer thickness in the range of from 0.4 to 3.2 mm. It is another object of the present invention to provide a polyamide molding composition which is flexible and uses a halogen-free flame-retardant. The modulus of elasticity of the molding composition, being a measure of flexibility, should be approximately in the range of the modulus of elasticity of the underlying polyamide (that for PA 12 being about 1400 MPa), but preferably lower. Other properties required are good compatibility of the additives with the polyamide matrix, and very low volatility.

This and other objects have been achieved by the present invention the first embodiment of which includes a molding composition, comprising:

a) from 43 to 93.5 parts by weight of at least one polyamide,

b) from 2 to 12 parts by weight of melamine cyanurate,

c) from 1.5 to 15 parts by weight of at least one polyol having at least 3 OH groups per molecule, and

d) from 3 to 30 parts by weight of at least one phosphorus compound of the formula

wherein

R¹, R², R³, and R⁴, independently of one another, are selected from the group consisting of
C₁-C₈-alkyl,
C₅-C₆-cycloalkyl, optionally substituted by C₁-C₄-alkyl,
C₆-C₂₀-aryl and
C₇-C₂₁-aralkyl,
each n is, independently of the others, 0 or 1,
m is a number from 0 to 50,
X is selected from the group consisting of
a mono- or polynuclear aromatic radical having from 6 to 30 carbon atoms, and
a linear or branched aliphatic radical having from 2 to 30 carbon atoms, which, optionally, has OH substitution, and contains up to 8 ether bonds,
with the proviso that the parts by weight of components a) to d) give a total of 100.

In another embodiment, the present invention provides a molding obtained from the above molding composition.

### DETAILED DESCRIPTION OF THE INVENTION

It has been found that molding compositions suitable for the purposes of the object described can be obtained, comprising the following components:
a) from 43 to 93.5 parts by weight, preferably from 50 to 91.75 parts by weight, particularly preferably from 55 to 89.5 parts by weight, and with particular preference from 61 to 87 parts by weight, of polyamide,
b) from 2 to 12 parts by weight, preferably from 2.5 to 11 parts by weight, particularly preferably from 3 to 10 parts by weight, and with particular preference from 4 to 8 parts by weight, of melamine cyanurate,
c) from 1.5 to 15 parts by weight, preferably from 1.75 to 12 parts by weight, particularly preferably from 2.5 to 10 parts by weight, and with particular preference from 3 to 8 parts by weight, of polyol, having at least 3 and preferably at least 4 OH groups per molecule, and
d) from 3 to 30 parts by weight, preferably from 4 to 27 parts by weight, particularly preferably from 5 to 25 parts by weight, and with particular preference from 6 to 23 parts by weight, of one or more phosphorus compounds of formula 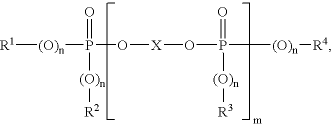
in which R¹, R², R³, and R⁴, independently of one another, have been selected from
C₁-C₈-alkyl,
C₅-C₆-cycloalkyl, if appropriate substituted by C₁-C₄-alkyl,
C₆-C₂₀-aryl and
C₇-C₂₁-aralkyl,
each n is, independently of the others, 0 or 1,
m is a number from 0 to 50, preferably 1, 2, 3, 4, 5, 6, 7, 8, 9, or 10,
X has been selected from
a mono- or polynuclear aromatic radical having from 6 to 30 carbon atoms, where the aromatic rings in polynuclear aromatic systems may have bonding by way of alkylene groups, and
a linear or branched aliphatic radical having from 2 to 30 carbon atoms, which, if appropriate, has OH substitution, and which can contain up to 8 ether bonds,
with the proviso that the parts by weight of components a) to d) give a total of 100.

The amount of a) includes all values and subvalues therebetween, especially including 45, 50, 55, 60, 65, 70, 75, 80, 85 and 90 parts by weight.

The amount of b) includes all values and subvalues therebetween, especially including 3, 4, 5, 6, 7, 8, 9, 10 and 11 parts by weight. The amount of c) includes all values and subvalues therebetween, especially including 2, 3, 4, 5, 6, 7, 8, 9, 10, 11, 12, 13 and 14 parts by weight.

The amount of d) includes all values and subvalues therebetween, especially including 5, 10, 15, 20 and 25 parts by weight.

Polyamides that can be used are mainly aliphatic homo- and copolycondensates, such as PA 46, PA 66, PA 68, PA 610, PA 612, PA 614, PA 410, PA 810, PA 1010, PA 412, PA 1012, PA 1212, PA 6, PA 7, PA 8, PA 9, PA 10, PA 11 and PA 12. The terminology for the polyamides corresponds to an international standard where the first numeral(s) give(s) the carbon number of the starting diamine and the second numeral(s) give(s) the carbon number of the dicarboxylic acid. If only one numeral is given, this means that the starting material was an α, ω-aminocarboxylic acid or the lactam derived therefrom; for further information reference may be made to H. Domininghaus, Die Kunststoffe and ihre Eigenschaften [Plastics and their properties], pp. 272 ff., VDI-Verlag, 1976.

If copolyamides are used these may contain, by way of example, adipic acid, suberic acid, sebacic acid, isophthalic acid, terephthalic acid, naphthalene-2,6-dicarboxylic acid, etc. as coacid and, respectively, bis(4-aminocyclohexyl)methane, trimethylhexamethylenediamine, hexamethylenediamine or the like as codiamine. There may also be lactams, such as caprolactam or laurolactam, or aminocarboxylic acids, such as ω-aminoundecanoic acid, incorporated as cocomponent.

The preparation of these polyamides is known (e.g. D. B. Jacobs, J. Zimmermann, Polymerization Processes, pp. 424-467, Interscience Publishers, New York, 1977; DE-B 21 52 194).

Other suitable polyamides are mixed aliphatic/aromatic polycondensates, e.g. as described in U.S. Pat. Nos. 2,071,250, 2,071,251, 2,130,523, 2,130,948, 2,241,322, 2,312,966, 2,512,606, and 3,393,210, and in Kirk-Othmer, Encyclopedia of Chemical Technology, 3rd ed., vol. 18, pp. 328 ff. and 435 ff., Wiley & Sons, 1982. It is, of course, also possible to use mixtures of different polyamides.

The melamine cyanurate is used in powder form. In one preferred embodiment, its D₅₀ grain size (diameter at 50%), measured via laser diffraction using a laser granulometer to BS ISO 13320-1, issue of 2000-03-15, is from 0.2 to 10 μm, particularly preferably from 0.4 to 8 μm, with particular preference from 0.7 to 6 μm, and very particularly preferably from 1 to 5 μm or from 1.5 to 4 μm. The D₅₀ grain size includes all values and subvalues therebetween, especially including 0.5, 1, 1.5, 2, 2.5, 3, 3.5, 4, 4.5, 5, 5.5, 6, 6.5, 7, 7.5, 8, 8.5, 9 and 9.5 μm. By way of example, a Cilas 715/920 laser granulometer can be used for the measurement.

By way of example, the polyol (c) can be a triol, such as trimethylolpropane or glycerol, or a derivative thereof, such as ditrimethylolpropane or diglycerol (produced via monoetherification of two molecules of the compounds mentioned), or a tetrol, such as erythritol, pentaerythritol, or a derivative thereof, such as di- or tripentaerythritol, a pentol, such as xylitol or arabitol, a hexol, such as mannitol, sorbitol, or the like. It is also possible to use higher adducts of the molecules mentioned, for example a branched or hyperbranched polyglycerol. It is, of course, also possible to use mixtures of polyols.

In the phosphorus compound (d), R¹, R², R³, and R⁴ are preferably, independently of one another, a C₁-C₄-alkyl radical, phenyl, naphthyl, or biphenylyl. The aromatic groups R¹, R², R³, and R⁴ can in turn have substitution with alkyl groups, preferably C₁-C₄-alkyl, and particular preference is given here to cresyl, xylenyl, propylphenyl, or butylphenyl.

X in the formula given is preferably a mono- or polynuclear radical of the following formula

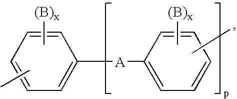

where A can be a single bond, C₁-C₅-alkylene, C₂-C₅-alkylidene, C₅-C₆- cycloalkylidene, —O—, —SO—, —CO—, —S—, —SO₂-, or C₆-C₁₂-arylene; each B is C₁-C₁₂-alkyl; each x is, independently of the others, 0, 1, or 2, and p is 0, 1, 2, 3, or 4.

A particularly preferred phosphorus compound is a compound or, respectively, a mixture of compounds of the formula given above in which R¹=R²=R³=R⁴=phenyl, n =1, m≦3, and X=

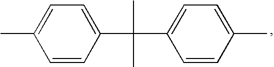

Alongside the constituents a) to d), the molding composition can also comprise relatively small amounts of added materials needed to establish particular properties. Examples of these are impact-modifying rubbers, plasticizers, dyes, pigments or fillers, such as carbon black, titanium dioxide, zinc sulfide, silicates, or carbonates, processing aids, such as waxes, zinc stearate, or calcium stearate, mold-release agents, glass beads, glass fibers, antioxidants, UV absorbers, HALS stabilizers, antioxidants, antidrip agents, and also additives which give the product antistatic properties or electrical conductivity, e.g. carbon fibers, graphite fibrils, stainless steel fibers, or conductive carbon black.

In one possible embodiment, the molding composition comprises from 1 to 25% by weight of plasticizer, particularly preferably from 2 to 20% by weight, and with particular preference from 3 to 15% by weight. The amount of plasticizer includes all values and subvalues therebetween, especially including 5, 10, 15, and 20% by weight.

Plasticizers and their use in polyamides are known. A general overview of plasticizers suitable for polyamides can be found in Gächter/Müller, Kunststoffadditive [Plastics additives], C. Hanser Verlag, 2nd edition, p. 296.

Examples of conventional compounds suitable as plasticizers are esters of p-hydroxybenzoic acid having from 2 to 20 carbon atoms in the alcohol component, or amides of arylsulfonic acids having from 2 to 12 carbon atoms in the amine component, preferably amides of benzenesulfonic acid.

Plasticizers that can be used are, inter alia, ethyl p-hydroxybenzoate, octyl p-hydroxybenzoate, isohexadecyl p-hydroxybenzoate, N-n-octyltoluenesulfonamide, N-n-butylbenzenesulfonamide, or N-2-ethylhexylbenzenesulfonamide.

The molding composition of the present invention is preferably prepared from the individual constituents via mixing in the melt in a kneading assembly. However, the method of preparation is not particularly limited.

In one preferred embodiment, the modulus of elasticity of the resultant molding composition, measured according to ISO 527, is at most 1500 MPa, preferably at most 1450 MPa, particularly preferably at most 1400 MPa, and with particular preference at most 1350 MPa. The minimum value for the modulus of elasticity is preferably 800 MPa, 900 MPa, 1000 MPa, or 1050 MPa. The modulus of elasticity includes all values and subvalues therebetween, especially including 100, 200, 300, 400, 500, 600, 700, 800, 900, 1000, 1100, 1200, 1300 and 1400 MPa. Addition of melamine cyanurate increases the modulus of elasticity, and addition of phosphorus compound reduces modulus of elasticity. The modulus of elasticity can be adjusted to the desired value via variation in these components.

Any of the conventional methods can be used on the molding composition of the present invention for production and further processing of moldings, for example via extrusion, coextrusion, blow molding, or injection molding. The term “molding” here includes sheet-like products, such as films or sheets.

It is also possible to use a process known as rapid prototyping or rapid manufacturing to process the molding composition of the present invention to give a three-dimensional molding. This term in particular describes layer-by-layer processes in which regions of the respective pulverulent layer are selectively melted and are hardened after cooling. Examples here are selective laser sintering, the SIB process as described in WO 01/38061, or a process as disclosed in EP-A-1 015 214. The two latter processes operate with infrared heating for melting of the powder. Selectivity of melting is achieved in the first process via application of an inhibitor and in the second process via a mask. US 2004/232583A1 describes another process; here, the energy needed for fusion is introduced via a microwave generator, and selectivity is achieved via application of a susceptor. Other suitable processes are those which operate with an absorber, either present in the powder or applied via inkjet methods, as described in the German patent applications WO 2005/090055, WO 2005/090056 and WO 2005/105412. A wide range of lasers can be used here in order to provide the electromagnetic energy, but another suitable method is provision of the electromagnetic energy across the entire surface.

The powder used for these processes can be prepared via grinding of the molding composition of the present invention, preferably at low temperatures. The ground product can then be fractionated in order to remove coarse particles or very fine particles. There can be subsequent mechanical post-treatment, e.g. in a high-speed mixer, for rounding of the particles. It is advisable to modify the resultant powder with a powder-flow aid, for example with fumed silica, which is incorporated by mixing within the dry blend. The number-average grain diameter of the resultant powder is preferably from 40 to 120 μm, and its BET surface area is preferably smaller than 10 m²/g. The number-average grain diameter includes all values and subvalues therebetween, especially including 50, 55, 60, 65, 70, 75, 80, 85, 90, 95, 100, 105, 110 and 115 μm.

As an alternative to this, some or all of the flame-retardant additives can be added to the polyamide during precipitation, in accordance with U.S. Pat. No. 5,932,687 or DE-A-44 21 454.

Another way of mixing the flame retardant combination with the pulverulent polyamide consists in adding the flame retardant combination in the form of a suspension or a solution in a suitable solvent, such as ethanol, if appropriate at an elevated temperature. This process distributes the flame retardants very uniformly onto the polyamide particles. The solvent is then removed via drying.

The moldings produced with the aid of this type of layer-by-layer process are flexible and flame retardant, as also are the moldings produced by means of injection molding or extrusion.

Application sectors for these moldings are available in rapid prototyping and also in rapid manufacturing. The latter means short runs, i.e. production of more than one identical part, in cases where production by means of an injection mold is not economic. Examples here are parts for high-specification cars of which only small numbers are produced, or replacement parts for motor sports, in which the important factors include not only small numbers but also availability time.

Having generally described this invention, a further understanding can be obtained by reference to certain specific examples which are provided herein for purposes of illustration only, and are not intended to be limiting unless otherwise specified.

### EXAMPLES

The materials stated in table 1 were used in the examples.

The PA 12 grades used differ in viscosity number (VN; measured to DIN EN ISO 307) and therefore in molecular weight.

The D₅₀ value of the melamine cyanurate was 2.69 μm.

ADK STAB FP-700 and ADK STAB FP-600 are phosphorus compounds of the formula

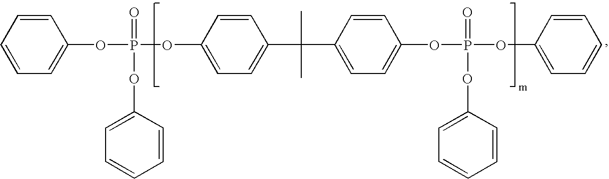

where the values of m differ. ADK STAB FP-700 has a m value of less than 1.1 on average. The m value of FP-600 is slightly higher, as the viscosity is 13000 mPas (25° C.).

ADK STAB FP-500 is a phosphorus compound of the formula

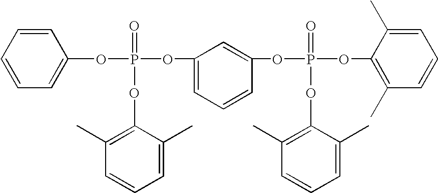

### Comparative Examples 1-4 (CE) and Examples 1-7 According to the Present Invention (IE)

Molding compositions of table 1 were prepared via mixing in the melt in an extruder and were subjected to a fire test. The results are given in table 1, together with the modulus of elasticity determined via a tensile test.

TABLE 1
Formulations and results

| | Inventive example (IE) or comparative example (CE) | | | | | | | | | | |
|---|---|---|---|---|---|---|---|---|---|---|---|
| | CE1 | CE2 | CE3 | IE1 | CE4 | IE2 | IE3 | IE4 | IE5 | IE6 | IE7 |
| Medium-viscosity PA 12, VN: 180 ml/g | | 80 | | | | | | | | | |
| High-viscosity PA 12, VN: 240 ml/g | 93 | | 82 | 68 | 68 | 68 | 68 | 68 | 68 | 68 | 80.5 |
| Melamine cyanurate | 7 | | 15 | 5 | 5 | 5 | 5 | 5 | 5 | 5 | 6 |
| ADK STAB FP-700 | | 20 | | 20 | | | | | | | |
| ADK STAB FP-600 | | | | | | | 20 | 20 | | | |
| ADK STAB FP-500 | | | | | | | | | 20 | 20 | 10 |
| Dipentaerythritol | | | | 7 | 7 | 7 | 7 | | | 7 | 3.5 |
| Pentaerythritol | | | 3 | | | | | 7 | 7 | | |
| Exolit AP 422 (ammonium polyphosphate) | | | | | 20 | | | | | | |
| Disflamoll DPK (diphenyl cresyl phosphate) | | | | | | 20 | | | | | |
| Tensile test ISO 527 | 1700 | 842 | 1629 | 1225 | 2618 | 1027 | 1205 | 1097 | 1146 | 1408 | 1315 |
| Modulus of elasticity MPa | | | | | | | | | | | |
| UL 94 fire test, stored in 23/50 standard temperature/ | | | | | | | | | | | |
| humidity conditions | | | | | | | | | | | |
| 0.4 mm | nd¹⁾ | nd¹⁾ | V-0 | V-0 | n.c.²⁾ | V-0 | V-0 | V-0 | V-0 | V-0 | V-0 |
| 0.8 mm | V-2 | V-2 | V-0 | V-0 | V-2 | V-0 | V-0 | V-0 | V-0 | V-0 | V-0 |
| 1.6 mm | V-2 | nd¹⁾ | V-2 | V-0 | V-2 | V-0 | V-0 | V-0 | V-0 | V-0 | V-0 |
| 3.2 mm | V-2 | nd¹⁾ | V-2 | V-0 | V-1 | V-0 | V-0 | V-0 | V-0 | V-0 | V-0 |

¹⁾nd = not determined
²⁾n.c. = no classification (i.e. poorer than V-2)

In assessment of the results it was apparent that the attempt to formulate for V-0 classification using melamine cyanurate alone or in combination with polyol gave a molding composition whose modulus of elasticity was too high. In contrast, if the pure phosphorus compound was used, flexible molding compositions with low modulus of elasticity were obtained, but their UL 94 classification was only V-2. A desired combination of flexibility and fire performance was only found when melamine cyanurate, phosphorus compound, and polyol were used together. If, for example, ammonium polyphosphate was used instead of the phosphorus compound of the claims, the result was not only impairment of fire performance but also disadvantageous increase in modulus of elasticity.

The following trends can be discerned within the examples of the present invention:
It was preferable to use pentaerythritol rather than dipentaerythritol, the reason being more advantageous price and lower modulus of elasticity.
ADK STAB FP-700 and FP-600 exhibited the best balance of the properties of flexibility (modulus of elasticity) of the molding composition and volatility of the phosphorus compound; FP-500 exhibited less plasticizing action, but also less volatility. Disflammol DPK exhibited greater plasticizing action, but also markedly higher volatility. When FP 700 and FP-600 were compared, the FP-600 appeared slightly superior in terms of volatility, because it comprises more oligomeric constituents.

Overall, it can be stated that markedly less melamine cyanurate had to be added when the flame retardant mixture of the present invention was used.

German patent application 10 2005 026265.1 filed Jun. 8, 2005, is incorporated herein by reference.

Numerous modifications and variations on the present invention are possible in light of the above teachings. It is therefore to be understood that within the scope of the appended claims, the invention may be practiced otherwise than as specifically described herein.

1. A molding composition, comprising:
a) from 43 to 93.5 parts by weight of at least one polyamide,
b) from 2 to 12 parts by weight of melamine cyanurate,
c) from 1.5 to 15 parts by weight of at least one polyol having at least 3 OH groups per molecule, and
d) from 3 to 30 parts by weight of at least one phosphorus compound of the formula 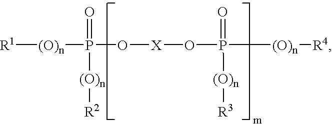
wherein
R¹, R², R³, and R⁴, independently of one another, are selected from the group consisting of
C₁-C₈-alkyl,
C₅-C₆-cycloalkyl, optionally substituted by C₁-C₄-alkyl,
C₆-C₂₀-aryl and
C₇-C₂₁-aralkyl,
each n is, independently of the others, 0 or 1,
m is a number from 0 to 50,
X is selected from the group consisting of
a mono- or polynuclear aromatic radical having from 6 to 30 carbon atoms, and
a linear or branched aliphatic radical having from 2 to 30 carbon atoms, which, optionally, has OH substitution, and contains up to 8 ether bonds,
with the proviso that the parts by weight of components a) to d) give a total of 100.

2. The molding composition as claimed in claim 1, wherein the polyamide is selected from the group consisting of PA 46, PA 66, PA 68, PA 610, PA 612, PA 614, PA 410, PA 810, PA 1010, PA 412, PA 1012, PA 1212, PA 6, PA 7, PA 8, PA 9, PA 10, PA 11, PA 12, and mixtures thereof.

3. The molding composition as claimed in claim 1, wherein the polyol contains at least 4 OH groups per molecule.

4. The molding composition as claimed in claim 1, which has a modulus of elasticity, measured according to ISO 527, in the range of from 900 to 1500 MPa.

5. The molding composition as claimed in claim 1, which is a powder.

6. A molding, produced from the molding composition as claimed in claim 1.

7. The molding as claimed in claim 6, which is a film.

8. A process for producing a molding, comprising:
molding the powder as claimed in claim 5 in a layer-by-layer process.

9. The molding composition as claimed in claim 1, wherein a copolyamide is used.

10. The molding composition as claimed in claim 1, wherein said polyamide is a mixed aliphatic/aromatic polycondensate.

11. The molding composition as claimed in claim 1, wherein mixtures of different polyamides are used.

12. The molding composition as claimed in claim 1, wherein said melamine cyanurate is a powder.

13. The molding composition as claimed in claim 1, wherein said melamine cyanurate has a D₅₀ grain size of from 0.2 to 10 μm.

14. The molding composition as claimed in claim 1, wherein said polyol (c) is a triol, a derivative of a triol, a tetrol, a derivative of a tetrol, a pentol, a derivative of pentol or mixtures thereof.

15. The molding composition as claimed in claim 1, wherein said phosphorus compound is a compound or a mixture of compounds of the formula given above in which R¹ =R² =R³ =R⁴ =phenyl, n =1, m ≦3, and

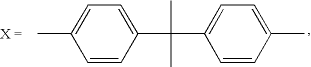

16. The molding composition as claimed in claim 1, comprising of from 1 to 25% by weight of a plasticizer.

17. The molding as claimed in claim 6, wherein the polyamide is selected from the group consisting of PA 46, PA 66, PA 68, PA 610, PA 612, PA 614, PA 410, PA 810, PA 1010, PA 412, PA 1012, PA 1212, PA 6, PA 7, PA 8, PA 9, PA 10, PA 11, PA 12, and mixtures thereof.

18. The molding as claimed in claim 6, wherein the polyol contains at least 4 OH groups per molecule.

19. The molding as claimed in claim 6, which has a modulus of elasticity, measured according to ISO 527, in the range of from 900 to 1500 MPa.

20. A molding produced by the process of claim 8.
